(19) United States
(12) Patent Application Publication
(10) Pub. No.: US 2023/0090601 A1
(43) Pub. Date: Mar. 23, 2023

(54) SYSTEM AND METHOD FOR POLARITY ANALYSIS

(71) Applicant: Zignal Labs, Inc., San Francisco, CA (US)

(72) Inventors: Andras BENKE, Bellevue, WA (US); Michael KRAMER, San Francisco, CA (US); Kaitlyn RASSI, Austin, TX (US); Heather Christiana MCCORMISH, San Francisco, CA (US); Bradley WHITE, Denver, CO (US); Ali ZAFARANI, Walnut Creek, CA (US); David ATLAS, San Francisco, CA (US); Alex SMITH, Chadron, NE (US)

(21) Appl. No.: 17/951,101

(22) Filed: Sep. 23, 2022

Related U.S. Application Data
(60) Provisional application No. 63/247,390, filed on Sep. 23, 2021.

(51) Int. Cl. G06F 16/31; G06F 40/284

(52) U.S. Cl. CPC G06F 16/31; G06F 40/284

(57) ABSTRACT

A system and method for determining polarization in a plurality of documents, which may be grouped in a variety of ways, for example according to publication source. The polarization may be determined according to an analysis of the document itself and/or of the publication source of the document. Optionally, topic modeling is performed on one or more documents from one or more sources as part of the above analysis. One or more topic models may then be applied for tagging one or more such documents.

### FIELD OF THE INVENTION

The present disclosure relates to the analysis of content for polarity and, more particularly to, analysis of content such as news content, event information, or textual documents, including with regard to particular events, for determination of polarity.

### BACKGROUND OF THE INVENTION

Polarity in media may be taken as any tendency to sort an aspect of a publication according to a binary scale, such as topics published, tone of articles and the like. Within US politics, this tendency may be expressed in regard to political party affiliation and/or “right” vs “left” belief systems. The Pew Research Center describes such a tendency as “political polarization” and has published a number of research pieces in this regard. Interestingly, this tendency is particularly strongly pronounced in the US, as the Pew Research Center determined that ideological divisions over various issues, such as cultural issues, are much less pronounced in the UK and Europe than in the US (https://www.pewresearch.org/fact-tank/2021/05/05/ideological-divisions-over-cultural-issues-are-far-wider-in-the-u-s-than-in-the-uk-france-and-germane/).

Given that political polarization appears to be increasing in the US, various measures have been considered to analyze such polarity with regard to media content. However, the current measures fall short as they are not sufficiently granular, analyzing such polarity only at the publication level.

### SUMMARY

The present invention, in at least some embodiments, relates to a system and method for determining polarization in a plurality of documents, which may be grouped in a variety of ways, for example according to publication source. The polarization may be determined according to an analysis of the document itself and/or of the publication source of the document. The terms “polarity” and “polarization” are used interchangeably herein. Optionally, topic modeling is performed on one or more documents from one or more sources as part of the above analysis. One or more topic models may then be applied for tagging one or more such documents. A “document” as used herein refers to a discrete textual datum, a collection of which creates a corpus. A story may comprise one or more documents. A larger story may for example be broken up into several documents according to modeling requirements. A smaller story in its entirety may form a document.

Optionally one method for tagging one or more documents with topic(s) may comprise applying a topic model generated from Hierarchical Dirichlet Processes (HDP) as described for example in U.S. patent application Ser. No. 17/224,224, filed on 7 Apr. 2021, entitled “SYSTEM AND METHOD FOR AUTOMATIC SUMMARIZATION OF CONTENT WITH EVENT BASED ANALYSIS”, owned in common with the present application, the contents of which are hereby incorporated by reference as if fully set forth herein. Tagging may also be performed according to Latent Dirichlet Allocation (LDA), to discover themes present in the targeted/detected event.

Tagging may also optionally be performed, additionally or alternatively, by applying one or more models derived from semantic embeddings, including but not limited to BERT (Bidirectional Encoder Representations from Transformers), SentenceBERT, RoBERTa, language related models, and their derivatives or related models. Preferably, one or more such models are selected that model specific topics and community language features.

According to at least some embodiments, the polarity analysis may be used to determine a Polarization Index, using a standardized scale (from least to most polarized) to represent the degree to which dialogue around certain issues, publications, demographic groups and brands may be considered to be polarized. Preferably, the polarity analysis comprises one or more polarity measures, which may be imported as a predetermined measure or model, and/or may be determined according to keywords or other such measures. A polarity measure is preferably standardized to form a Polarization Index.

Non-limiting examples of issues that may be so analyzed relate to any topics reported as “news” or “current events”, as well as other such topics. A publication may be an online newspaper or magazine, blog, newsletter, podcast, television show, social media platform, and the like. Demographic groups may relate to any coherent group having one or more recognized demographic characteristics, including but not limited to age, race and/or ethnicity, gender identification, political affiliation, religious affiliation, other affiliative organizations, educational level, employer, type of job, geographic location and the like. Brands may be analyzed with regard to one or more of their brand announcements, sponsored content and direct content (the latter of which may relate to any publication controlled by a brand, including but not limited to, a social media channel, website, self-published book or magazine and the like), and also associated content, such as publications in which their advertisements are placed.

The degree of polarization is measured by ingesting and analyzing mentions from traditional, digital, and social media. Such a degree of polarization preferably comprises one or more measurements of polarization as described herein. Target keywords, subject matter, domains/publications, users, and forums may be applied to guide such ingestion. Ingestion may operate in a distributed fashion, harvesting mentions based on the definitions given by the aforementioned targets and grouping them for analysis and display. After ingestion, mentions may be categorized by domain of publication, for example by using Ad Fontes' Media Bias Chart classification system (described in the following publication: https://www.adfontesmedia.com/), which places each domain of publication on both a political and reliability spectrum, providing the lens in which the data will be examined. Other non-limiting examples of publication polarization ratings include Allsides (https://www.allsides.com/media-bias/media-bias-ratings), the Pew Research Center's model for ideological placement of media sources (https://www.journalism.org/2014/10/2l/political-polarization-media-habits/pi 14-10-21 mediapolarization-08/), and the media bias chart from Sharyl Attkisson (https://sharylattkisson.com/2018/08/media-bias-a-new-chart/). Each of these publication polarization rating systems or models may be applied as a polarization model and/or imported to form a polarization measure.

A polarization measure may also be determined according to a plurality of keywords related to issues that relate to any topics reported as “news” or “current events”, as well as other such topics. Optionally, a machine learning, AI and/or deep learning model may be trained according to one or more polarization measures, and preferably according to a plurality of documents characterized or labeled according to such one or more polarization measures. Non-limiting examples of training methods are provided herein and also as described for example in U.S. patent application Ser. No. 17/224,224, filed on 7 Apr. 2021, entitled “SYSTEM AND METHOD FOR AUTOMATIC SUMMARIZATION OF CONTENT WITH EVENT BASED ANALYSIS”, owned in common with the present application, the contents of which are hereby incorporated by reference as if fully set forth herein.

Optionally mentions are characterized by topic as well, for example by applying a topic model to the mentions (documents) to determine to which topic each document belongs. Optionally a tone is determined for each document, to further determine an echo chamber score for the document. The tone may be determined by topic. Optionally, additionally or alternatively, community language models are applied to each document to classify polarized community affiliation based on language usage. Optionally and preferably both topic analysis and publication analysis are applied to determine a polarization score. Preferably, such a polarization score is determined according to one or more polarization models.

The volume and/or quality of mentions, distributed across the political and reliability spectrum, illustrates the distance between perspectives within a particular publication and/or within a particular topic, while the degree of engagement within each perspective represents the strength of opinion. By “quality” it is meant such parameters as the degree of interaction with the mentions, which may be determined according to the number of shares and/or reshares, or other measurements of amplification. Preferably, the Polarization Index is both the measure of “distance apart” and “engagement” with polarizing perspectives.

Optionally, for analysis to determine a polarization measure and/or for training a model, the documents may be analyzed in a variety of ways. For example, optionally documents are first analyzed according to topic based profiles, after which one or more media category filters are applied. Such media category filters may relate to keywords or other measures of media categories. Alternatively, media category profiles are first applied, and then topic based filters are applied. Optionally, in either case, application of topic models and filters are used to generate engagement scores.

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The terms “information”, “stories”, “content” and “media content” may be used interchangeably herein. Further, the terms “customer”, “user” and “audience” may be used interchangeably herein. Furthermore, the terms “topic” and “theme” may be used interchangeably herein.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Unless otherwise defined, all technical and scientific terms used herein have the same meaning as commonly understood by one of ordinary skill in the art to which this invention belongs. The materials, methods, and examples provided herein are illustrative only and not intended to be limiting.

An algorithm as described herein may refer to any series of functions, steps, one or more methods or one or more processes, for example for performing data analysis.

Implementation of the apparatuses, devices, methods and systems of the present disclosure involve performing or completing certain selected tasks or steps manually, automatically, or a combination thereof. Specifically, several selected steps can be implemented by hardware or by software on an operating system, of a firmware, and/or a combination thereof. For example, as hardware, selected steps of at least some embodiments of the disclosure can be implemented as a chip or circuit (e.g., ASIC). As software, selected steps of at least some embodiments of the disclosure can be implemented as a number of software instructions being executed by a computer (e.g., a processor of the computer) using an operating system. In any case, selected steps of methods of at least some embodiments of the disclosure can be described as being performed by a processor, such as a computing platform for executing a plurality of instructions. The processor is configured to execute a predefined set of operations in response to receiving a corresponding instruction selected from a predefined native instruction set of codes.

Software (e.g., an application, computer instructions) which is configured to perform (or cause to be performed) certain functionality may also be referred to as a “module” for performing that functionality, and also may be referred to a “processor” for performing such functionality. Thus, processor, according to some embodiments, may be a hardware component, or, according to some embodiments, a software component.

Further to this end, in some embodiments: a processor may also be referred to as a module; in some embodiments, a processor may comprise one or more modules; in some embodiments, a module may comprise computer instructions-which can be a set of instructions, an application, software-which are operable on a computational device (e.g., a processor) to cause the computational device to conduct and/or achieve one or more specific functionality.

Some embodiments are described with regard to a “computer,” a “computer network,” and/or a “computer operational on a computer network.” It is noted that any device featuring a processor (which may be referred to as “data processor”; “pre-processor” may also be referred to as “processor”) and the ability to execute one or more instructions may be described as a computer, a computational device, and a processor (e.g., see above), including but not limited to a personal computer (PC), a server, a cellular telephone, an IP telephone, a smart phone, a PDA (personal digital assistant), a thin client, a mobile communication device, a smart watch, head mounted display or other wearable that is able to communicate externally, a virtual or cloud based processor, a pager, and/or a similar device. Two or more of such devices in communication with each other may be a “computer network.”

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. The drawings referred to in this

description are not to be understood as being drawn to scale except if specifically noted, and such drawings are only exemplary in nature.

In the drawings:

FIGS. 1A-1C show non-limiting illustrative examples of polarization analysis systems;

FIGS. 2A-2B show non-limiting illustrative examples of methods for document analysis for polarization;

FIG. 3 shows a non-limiting illustrative example of a method for document preprocessing;

FIG. 4 shows a non-limiting illustrative example of a method for polarization monitoring;

FIGS. 5A and 5B show non-limiting illustrative examples of methods for document analysis for polarization in a publication over time;

FIG. 6 shows a non-limiting illustrative example of a method for polarization monitoring for a specific group;

FIG. 7 shows a non-limiting illustrative example of a method for polarization monitoring for a specific brand;

FIG. 8 shows a method for applying transfer learning to create a community based language classifier to detect polarity based upon community membership; and

FIG. 9 shows an exemplary method for data ingestion.

### DETAILED DESCRIPTION

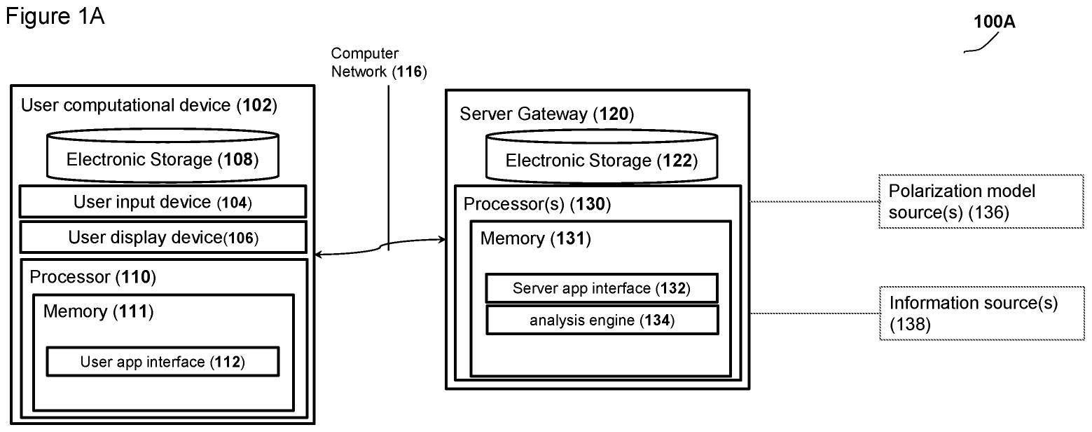

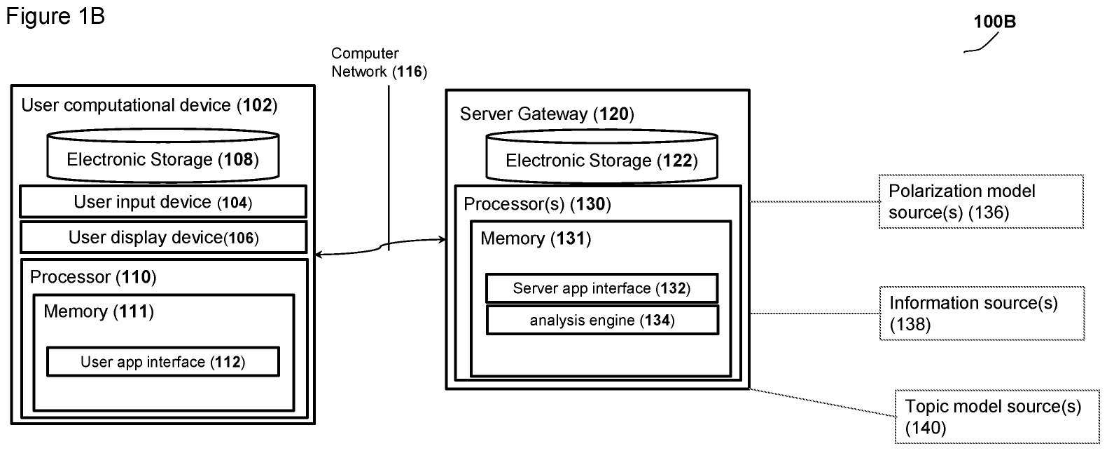

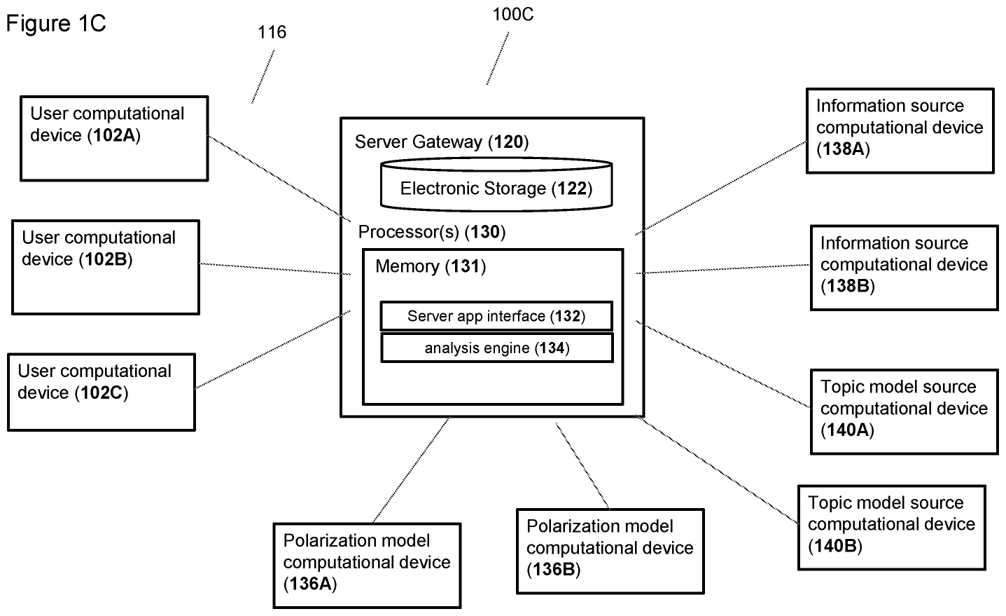

FIGS. 1A-1C show non-limiting illustrative examples of polarization analysis systems. FIG. 1A shows an exemplary polarization analysis system. As shown in a system 100A, a user computational device 102 communicates with a server gateway 120 through a computer network 116. Server gateway 120 in turn communicates with one or more additional servers, for example to access one or more polarization model sources 136. Polarization models may be determined as described herein, for example according to one or more predetermined publication polarization or bias scores, and/or models determined according to a plurality of documents that have been labeled or tagged according to such publication polarization or bias scores and/or methodologies. With regard to document analysis, each document may be analyzed according to one or more of source publication, polarization or bias in the language of the document itself, and/or polarization or bias with regard to a topic of the document. Server gateway 120 also preferably communicates with one or more information source(s) 138, which are preferably provided in real time.

Server gateway 120 preferably comprises an analysis engine 134 for analyzing one or more information source(s) 138, preferably in real time, according to one or more polarization models. For example, analysis engine 134 may analyze each information source 138 according to one or more polarization models as described herein. Optionally such analysis may determine that an event is occurring, such that the analysis would relate to event analysis. The polarization models may also be trained or retrained according to the analysis.

Analysis engine 134 may analyze documents from one or more information source(s) 138 to be able to apply a polarization model to such documents, both short form and long form.

Through user computational device 102, the user may determine which polarization model(s) and/or polarization model source(s) 136 are relevant for analysis through a user interface 112. The user may also select one or more information source(s) 138 through user interface 112. The user may also select one or more documents for review according to such application of a polarization model through user interface 112.

User computational device 102 preferably includes the user input device 104, and user display device 106. The user input device 104 may optionally be any type of suitable input device including but not limited to a keyboard, microphone, mouse, or other pointing device and the like. Preferably user input device 104 includes a list, a microphone and a keyboard, mouse, or keyboard mouse combination.

User computational device 102 also comprises a processor 110 and a memory 111. Functions of processor 110 preferably relate to those performed by any suitable computational processor, which generally refers to a device or combination of devices having circuitry used for implementing the communication and/or logic functions of a particular system. For example, a processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in a memory, such as a memory 111 in this non-limiting example. As the phrase is used herein, the processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Also optionally, memory 111 is configured for storing a defined native instruction set of codes. Processor 110 is configured to perform a defined set of basic operations in response to receiving a corresponding basic instruction selected from the defined native instruction set of codes stored in memory 111. For example and without limitation, memory 111 may store a first set of machine codes selected from the native instruction set for receiving information from the user through user app interface 112 and a second set of machine codes selected from the native instruction set for transmitting such information to server gateway 120 in regard to one or more commands for analyzing documents, for example according to one or more polarization models and/or one or more information sources.

Similarly, server gateway 120 preferably comprises processor 130 and memory 131 with machine readable instructions with related or at least similar functions, including without limitation functions of server gateway 120 as described herein. For example and without limitation, memory 131 may store a first set of machine codes selected from the native instruction set for receiving topic model(s) from topic model source(s) 136, a second set of machine codes selected from the native instruction set for receiving information from one or more information source(s) 138, and a third set of machine codes selected from the native instruction set for executing functions of analysis engine 134.

User computational device 102 preferably comprises an electronic storage 108 for storing data and other information. Similarly, server gateway 120 preferably comprises an electronic storage 122.

FIG. 1B shows another exemplary polarization analysis system, in which topic models are also applied. Items with the same reference numbers as FIG. 1A have the same or similar function. A system 100B features both analysis according to one or more polarization models and also one or more topic models. The topic models may be obtained for example from one or more topic model sources 140. Documents from one or more information sources 138 may be tagged. Such tagging may then enable one or more topics to be assigned to each such document. Optionally one method for tagging one or more documents with topic(s) may comprise applying a Hierarchical Dirichlet Process (HDP). Optionally the HDP process may be applied for organic topic discovery, such that the HDP may be applied directly to documents from the one or more information source(s) 138, and the resultant topic models may then be stored in one or more topic model source(s) 136. HDP may also be applied to analyze development of, and changes to, a topic over time, for example in relation to an event. A combination of these approaches may also be applied.

Through user computational device 102, the user may determine which topic model(s) and/or topic model source(s) 140 are relevant for analysis through a user interface 112. The user may also select one or more polarization models from one or more polarization model sources 136. Such selected models may then be applied in combination to a document, for example to determine polarization in regard to the document and/or in regard to a topic covered by the document.

Word Embeddings trained on community specific documents may be used to determine the presence of said community within the documents comprising the target data. Word Embeddings can be trained via Word2Vec, BERT, or FastText. The extent to which such documents are published, and/or the quality of such published documents (mentions) as previously described, may also be used to determine polarization in regard to the document or event. Transfer learning may also be used within this approach to create a community membership classifier based on language usage.

FIG. 1C shows another exemplary polarization analysis system. Items with the same reference numbers as FIGS. 1A or 1B have the same or similar function. As shown in a system 100C, a plurality of user computational devices 102, shown as user computational devices 102A-102C for the purpose of illustration only and without any limitation, communicate with server gateway 120. Functions of, and communication between, user computational devices 102A-102C and server gateway 120, may for example be performed as described with regard to FIGS. 1A or 1B.

Server gateway 120 in turn communicates with a plurality of information source computational devices 138, shown as information source computational devices 138A-138B for the purpose of illustration only and without any intention of being limiting. Server gateway 120 also communicates with a plurality of polarity model source computational devices 136, shown as polarity model source computational devices 136A-136B for the purpose of illustration only and without any intention of being limiting. Server gateway 120 also communicates with a plurality of topic model source computational devices 140, shown as topic model source computational devices 140A-140B for the purpose of illustration only and without any intention of being limiting.

Analysis engine 134 obtains documents from information source computational devices 138A-138B, for example according to a particular time period or time window as described herein, and then applies one or more polarity models to determine polarization of the documents and/or of the topics as contained within the documents. For the latter, optionally analysis engine 134 also performs topic discovery on such documents. Optionally topics may also be obtained from topic model source computational devices 136A-136B. Analysis engine 134 preferably detects changes in polarization, optionally with regard to each topic over time, including without limitation in regard to velocity (rate of change) in the number of documents mapped to each such topic having a particular polarization. As another non-limiting example, analysis engine 134 also detects changes in polarization over time in regard to documents obtained from a specific publication source, associated with a specific demographic group, or provided by and/or associated with a particular brand.

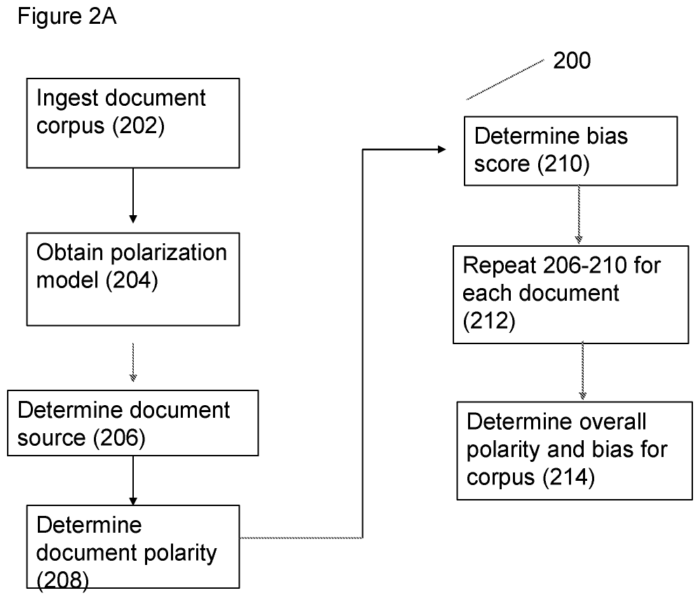

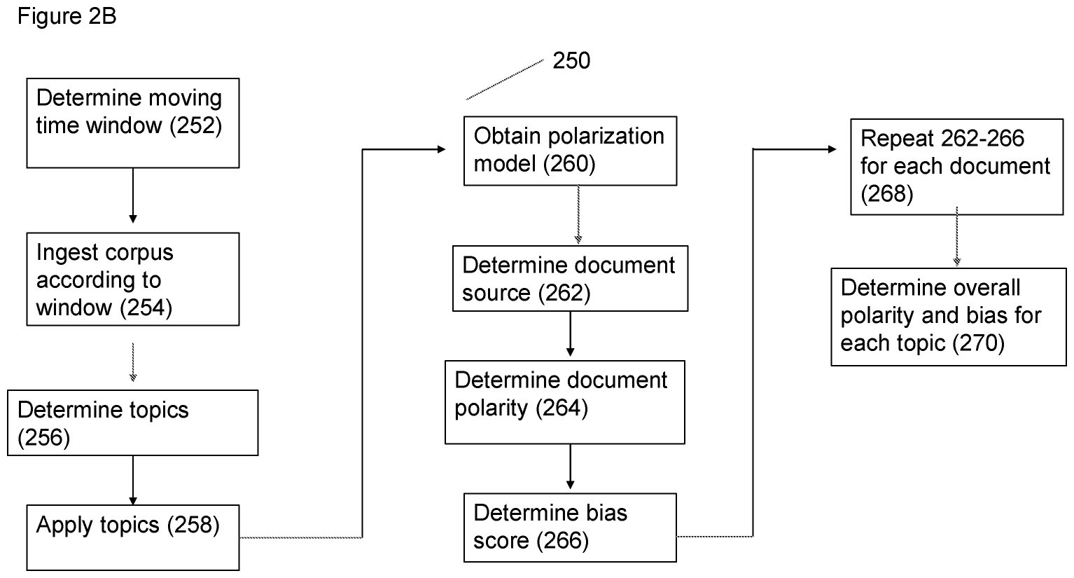

FIGS. 2A-2B show non-limiting illustrative examples of methods for document analysis for polarization. FIG. 2A shows a method 200, in which the process begins by ingesting a document corpus at 202. The document corpus may relate to documents from a particular publication or may otherwise be grouped according to one or more criterion. At 204, a polarization model is obtained. The polarization model may relate to the determination of polarization with regard to a particular publication (document source), and/or for such a determination in regard to the language of the document itself.

At 206, if the document source is to be analyzed as part of the application of the polarization model, then the document source is determined for each such document. At 208, the document polarity is determined by applying one or more polarity models. Next, optionally at 210, a bias score is identified, preferably from the language of the document itself. The application of one or more polarity models in 208 may also relate to analysis of the document language, in which case step 210 is optionally not performed.

At 212, steps 206-210 are preferably repeated for each document in the ingested corpus. At 214, optionally the overall polarity and/or bias scores are determined for the entire corpus. For example, if the corpus relates to documents from a specific publication, then the polarity and/or bias scores may be determined for the publication itself. If the corpus relates to documents covering a particular news event, then the polarity and/or bias scores may be determined for the news event itself, at least as handled by the media.

Turning now to FIG. 2B, in a method 250, the process begins by determining a moving time window at 252, for ingesting documents. The time window may comprise any suitable time period, including without limitation 1 minute, 5 minutes, 10 minutes, 15 minutes, 30 minutes, 60 minutes, 2 hours, 8 hours, 12 hours 24 hours, 48 hours, 72 hours, 1 week, 1 month or any suitable multiday period, or any value in between. For example and without limitation, the time period may be 72 hours. Next, the corpus of documents is ingested according to the moving window 254. For example and without limitation, if the time period is set to 72 hours, then the corpus of documents would be ingested over 72 hours and then analyzed according to the below method. The corpus may be updated in separate non-overlapping 72 hour chunks but is preferably updated according to a sliding window. The sliding window may be run or applied every hour, every 2, 3, 4, 8, 12, 24, 36, 48, 60 hours and every suitable time period in between. Such application frequency is suitable, without wishing to be limited to a closed list, for the narratives to naturally form; incorporated into the corpus according to the velocity and volume with which they emerge while simultaneously making the overlap of local-topics and term-vectors easier to detect and/or calculate from a similarity perspective.

At 256, preferably one or more topics are determined according to the application of the HDP to the corpus as described herein, for topic discovery. Such topic(s) are preferably determined as having a cumulative probability above a certain threshold. Each determined topic is then assigned a unique identifier (id). Optionally as part of this process, a plurality of topics are merged according to assessed similarity.

Merging is preferably performed by comparing the similarity of topics. Similarity is determined by, but not limited to, some of the following algorithmic approaches: Jaccard Similarity calculated over the topic terms; projecting the terms into a vector space using Word2Vec and comparing similarity via cosine distance; removing the “most common” tokens and then comparing the remaining sets to each other via Jaccard or cosine similarity; volumetric based similarity between tagged sets. The merged topics are preferably assigned a global identifier (id), to identify them as a group.

At 258, the corpus of documents determined according to the moving window is preferably analyzed and tagged according to the merged topics. Preferably such tagging maps each document to a suitable merged topic group, after which the global id for that merged topic group is assigned to that document. Optionally, a document may have more than one, or none, of the merged topic groups assigned to it.

Steps 260-266 may be performed as described with regard to steps 204-210 as described with regard to FIG. 2A. At 268, preferably steps 262-266 are repeated for all documents. At 270, the overall polarity and bias may be determined for each topic.

Optionally each topic may relate to a particular domain. A domain as used herein relates to the information sector, including but not limited to Technology, Climate Change, COVID-19, National Security, Public Policy, Healthcare, Finance, and so forth. A domain may also refer to “area of interest” specified by a user for example. A domain may be more generically “current affairs news sources” to allow modelling for “breaking news” and emergent narratives. Combinations of these types of domains may also be implemented. The profile preferably includes information sources and terms believed to filter and distill the information pertinent to that domain. The job may be time limited as described above, for example to retrieve documents within a particular time window, which may then be stored.

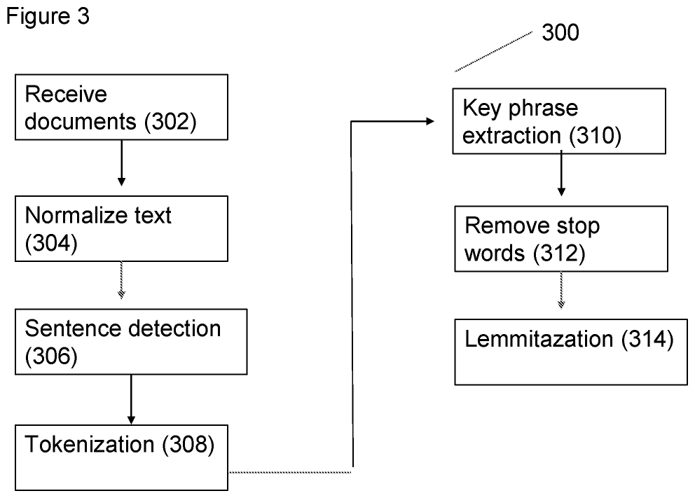

FIG. 3 shows a non-limiting illustrative example of a method for document preprocessing. In a method 300, the process begins with receiving documents, for example from the previously described time window delimited process, to form a corpus at 302. Once a corpus is large enough to be useful for topic modeling and training purposes, the documents are cleaned. The cleaning process preferably starts by normalizing text at 304, for example as follows: URLs are extracted, certain characters are removed, spelling correction is applied if necessary, character encodings are standardized.

At 306, preferably text is broken up into sentences using a machine learning approach for boundary detection. Any suitable sentence detection algorithm may be used, including without limitation the sentence detector algorithm provided within Spark NLP

(https://nlp.johnsnowlabs.com/docs/en/annotators#sentencedetector;
https://nlp.johnsnowlahs.com/2020/09/13/sentence_detector_dl_en.html).

At 308, individual sentences are tokenized. For languages such as English, whitespace tokenization may be used. However, tokenization in this context is preferably performed differently than tokenization as described previously with regard to stories and separate documents. Tokenization in this context preferably refers to separating sentences into words.

At 310, Key Phrases are extracted from the sentence, for example according to the YAKE! algorithm (“YAKE! Keyword extraction from single documents using multiple local features”, Campos et al, Information Sciences, Volume 509, January 2020, Pages 257-289).

At 312, stopwords are removed from the token vector. At 314, lemmatization is applied to the remaining tokens. The full preprocessed set of data preferably features lemmatized tokens and n-gram key phrases.

Optionally, for training purposes, before preprocessing each document is analyzed for polarization. Such an analysis may be performed manually, for example according to one or more polarity methods as described herein, or automatically. For automatic analysis, optionally a polarization measure, and preferably a Polarization Index as described herein, is applied to determine bias. Also optionally, again for training purposes, before preprocessing each document is analyzed for a bias score with regard to the language used. Such an analysis may be performed manually or automatically, according to a bias rubric or scoring method as described herein.

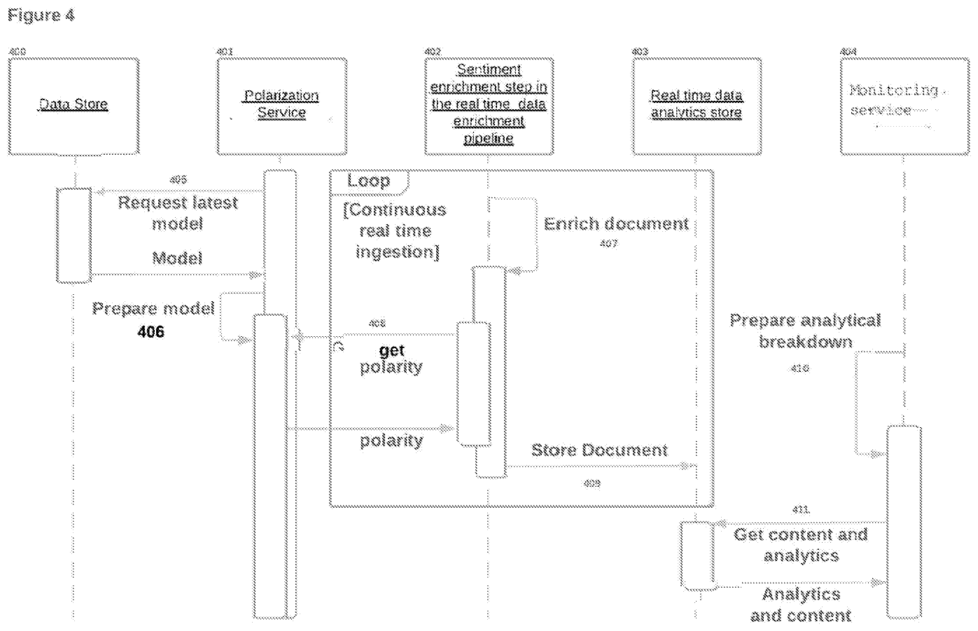

FIG. 4 shows a process for model usage, featuring data store 400, a polarization service 401, and a sentiment enrichment step in the real time data enrichment pipeline 402. The pipeline 402 adds analytical metadata to documents as they are collected. A real time data analytics store 403 stores the analyzed information and may also interact with a monitoring service 404 to perform polarization monitoring. Analytics store 403 provides access to the ingested content as well as a platform for running analytical queries on demand. Monitoring service 404 may contain a suite of tools such as smart signage, command centers, and web applications that provide real time insights into conversations around particular publications, topics, demographic groups and/or brands, in regard to polarization.

In a process 405, polarization service 401 requests the latest model from data store 400, which is then transferred into polarization service 401. Now the model is prepared at 406 by polarization service 401, which loads in the model and starts a rest service to allow access to its automatic reputation polarity evaluations.

As part of a loop, the reputation polarity is requested by sentiment enrichment step 402 in a process 408. One step in the enrichment process is determination of polarity of a particular document. During this step, the pipeline makes a request to the polarity service with the textual information from the tweet or the profile based highlights from longform content. The polarity is then fed to sentiment enrichment 402.

As the loop continues, the polarity is examined, and the document is enriched in a process 407, through continuous real time ingestion. The real time data enrichment pipeline continuously augments documents with additional analytical information.

As the documents are enriched they are stored in their enriched form in a process 409 to real time data analytics store 403. This loop process preferably happens continuously as more documents come in.

As new documents are provided to real time data analytics store 403, monitoring solution 404 prepares an analytical breakdown 410 according to a user initiated request. Some non-limiting examples of such an analysis include determining a time series by a polarization measure for a profile (data stream driven by taxonomy) and influential authors, top authors by mention count, top sites by mention count, word cloud, emoji cloud for a given sentiment. An analytical breakdown features a plurality of widgets providing analytical value (like those listed) grouped together. While there are many use cases for such analysis, one non-limiting example of such a case is in the preparation of analytical dashboards that provide insights on a brand over a requested time frame.

Next, solutions 404 then gets content and analytics in 411, which are then delivered to monitoring service 404. Process 410 indicates the start of the task build out for an analytical breakdown; part of that task relates to obtaining content and analytics.

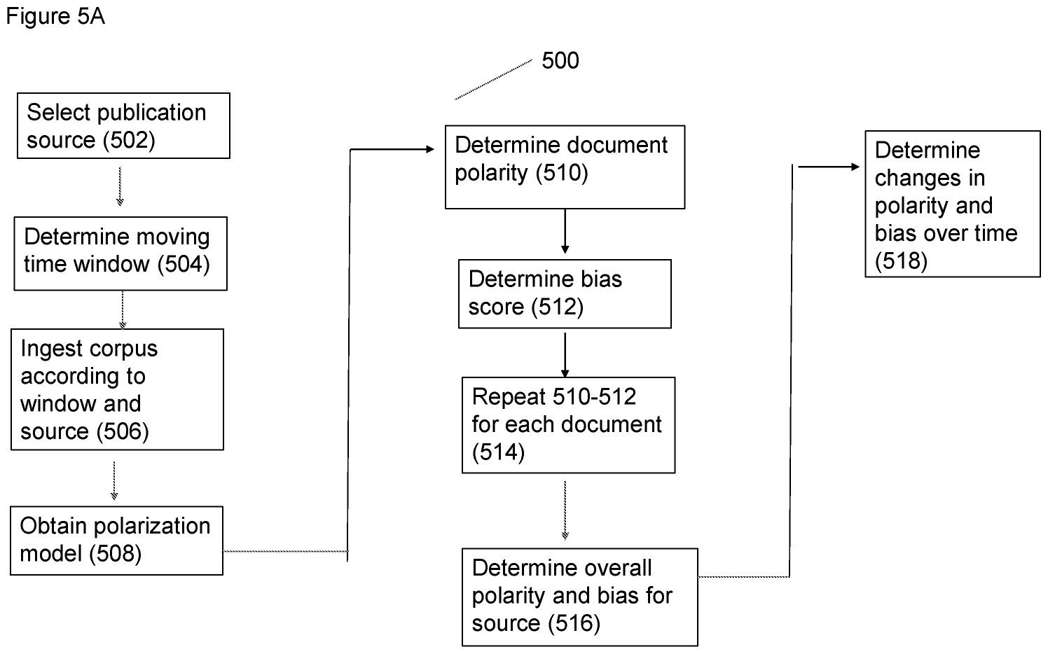

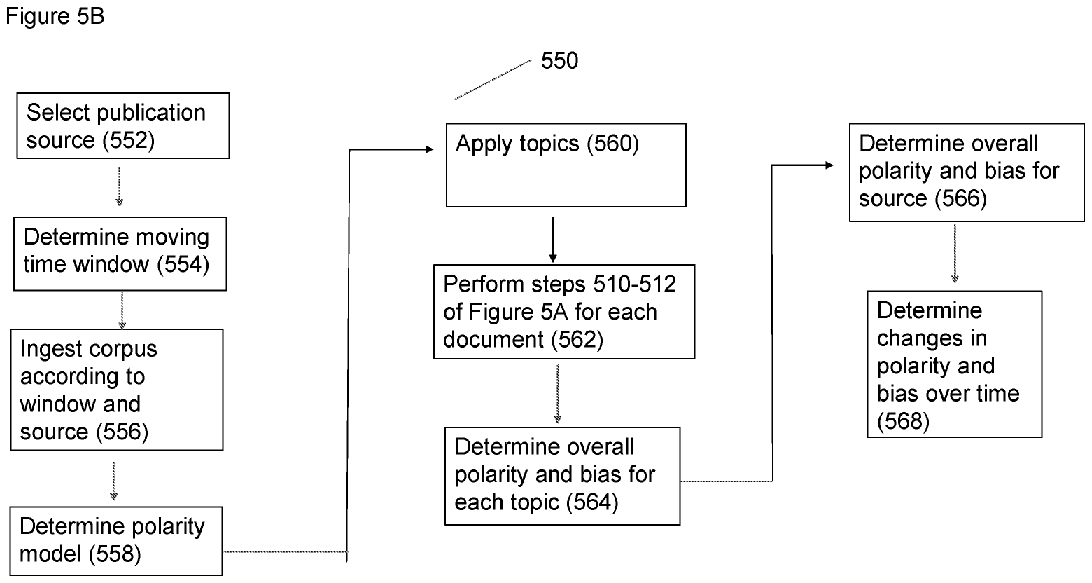

FIGS. 5A and 5B show non-limiting illustrative examples of methods for document analysis for polarization in a publication over time. FIG. 5A relates to a method for determining polarization in a specific publication over time. In a method 500, the process begins by selecting a specific publication, which may for example comprise a newspaper, news aggregator, television show, magazine, podcast, newsletter and the like, at 502. A moving time window is then selected, for example as described herein, at 504. Next at 506, the process continues by ingesting a document corpus from that specific publication according to the selected time window. At 508, a polarization model is obtained. The polarization model may relate to the determination of polarization with regard to a particular publication (document source), and/or for such a determination in regard to the language of the document itself.

At 510, the document polarity is determined by applying one or more polarity models. Next, optionally at 512, a bias score is identified, preferably from the language of the document itself. The application of one or more polarity models in 510 may also relate to analysis of the document language, in which case step 512 is optionally not performed.

At 514, steps 510 and 512 are preferably repeated for each document in the ingested corpus. At 516, optionally the overall polarity and/or bias scores are determined for the entire corpus and hence for the publication itself. At 518, optionally changes to the overall polarity and/or bias scores over time are determined for the publication. Such changes may then be compared to the changes determined for one or more other publications, for example.

FIG. 5B relates to a method for determining polarization in a specific publication over time in regard to one or more specific topics. As shown in a method 550, steps 552-558 may be performed as described with regard to steps 202-208 of FIG. 5A. At 560, one or more topics are determined, for example according to one or more topic models as described herein, and are then applied to the documents. At 562, steps 510-512 of FIG. 5A are performed for each document, optionally also according to the applied topic. At 564, an overall bias and/or polarity is determined for each topic within the documents. At 566, an overall bias and/or polarity is determined for the source itself. At 568, changes in overall bias and/or polarity over time are determined for the topic in regard to the source.

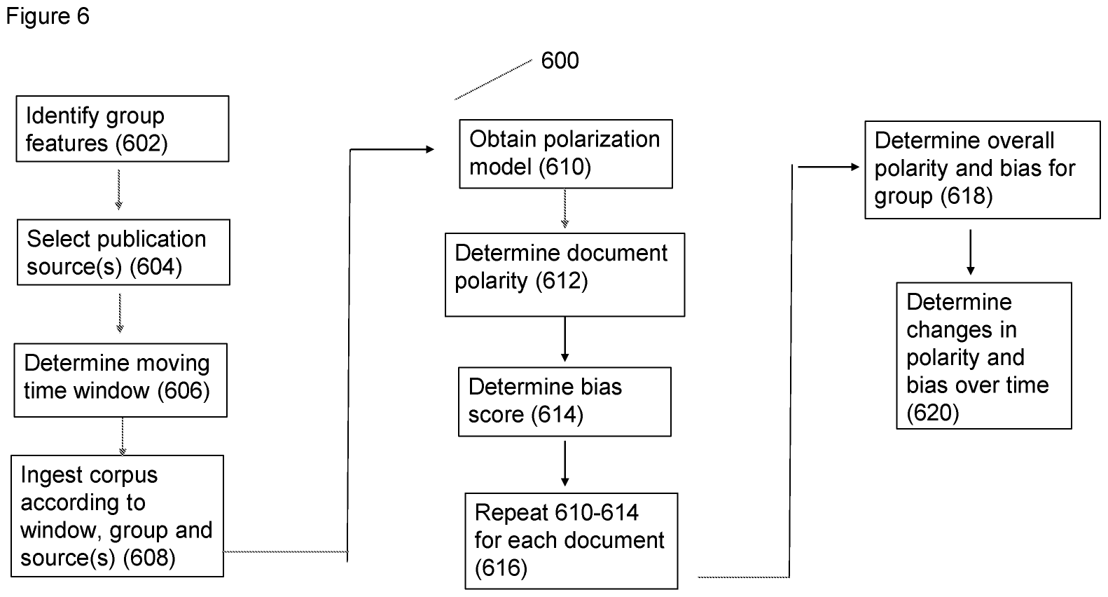

FIG. 6 shows a non-limiting illustrative example of a method for polarization monitoring for a specific group. As shown in a method 600, the process begins at 602 by identifying a particular group according to one or more characteristics. Such characteristics may relate to any recognized demographic characteristics, including but not limited to age, race and/or ethnicity, gender identification, political affiliation, religious affiliation, other affiliative organizations, educational level, employer, type of job, geographic location and the like, or a combination thereof. At 604, one or more publication sources are optionally selected for analysis. Such publication sources may be known to be read, listened to, watched or otherwise interacted with by the specific group, for example. Any suitable type of publication source as described herein may be selected according to their interactions with the specific group.

At 606, a moving time window is selected as described herein, according to which the documents are to be selected for ingestion. At 608, the corpus of documents is preferably ingested as selected according to the selected group, time window and publication source(s). At 610, the polarization model is obtained as described herein. The polarization model may relate to the determination of polarization with regard to a particular publication (document source), and/or for such a determination in regard to the language of the document itself. The polarity model may for example incorporate a predetermined polarity measure, optionally including a Polarization Index as described herein.

At 612, the document polarity is determined by applying one or more polarity models. Next, optionally at 614, a bias score is identified, preferably from the language of the document itself. The application of one or more polarity models in 612 may also relate to analysis of the document language, in which case step 614 is optionally not performed.

At 616, steps 612 and 614 are preferably repeated for each document in the ingested corpus. At 618, optionally the overall polarity and/or bias scores are determined for the entire corpus and hence for the group itself. At 620, optionally changes to the overall polarity and/or bias scores over time are determined for the group. Such changes may then be compared to the changes determined for one or more other groups, for example.

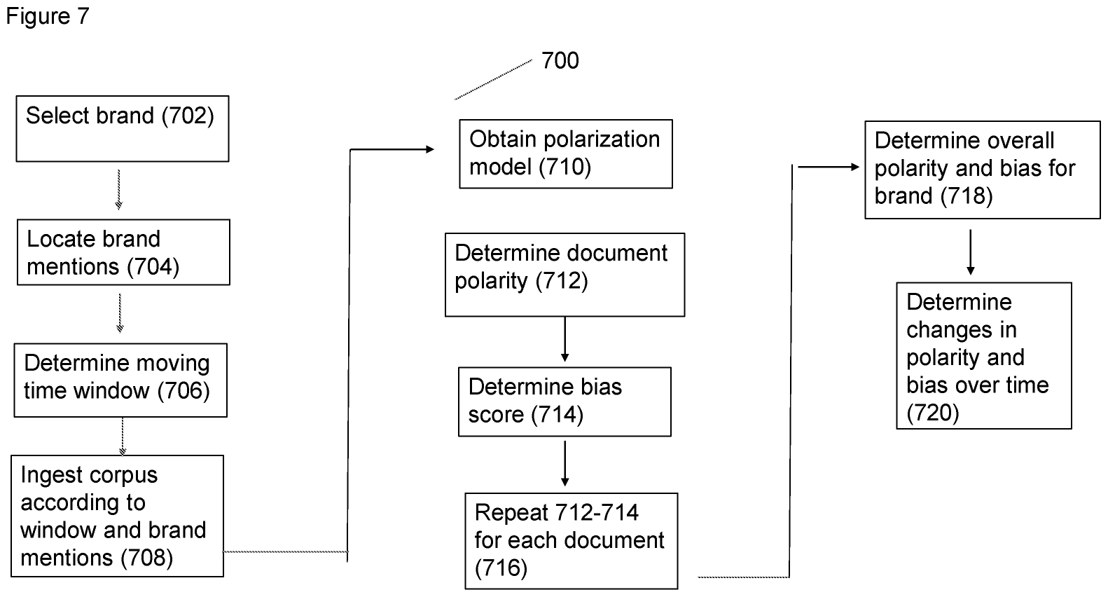

FIG. 7 shows a non-limiting illustrative example of a method for polarization monitoring for a specific brand. As shown in a method 700, the process begins at 702 by identifying a brand according to one or more characteristics. Such characteristics may relate to a name, logo, trade name, trade slogan and the like, associated with the brand in question. At 704, one or more brand mentions are located within any type of content, including any suitable type of publication as described herein, and additionally with regard to any social media platform or channel, as well advertisements and the like, and/or content provided, sponsored or otherwise controlled by the brand. Documents associated with that content may then be selected for ingestion and analysis.

At 706, a moving time window is selected as described herein, according to which the documents are to be selected for ingestion. At 708, the corpus of documents is preferably ingested as selected according to the selected time window and brand mentions. At 710, the polarization model is obtained as described herein. The polarization model may relate to the determination of polarization with regard to a particular publication (document source), and/or for such a determination in regard to the language of the document itself.

At 712, the document polarity is determined by applying one or more polarity models. Next, optionally at 714, a bias score is identified, preferably from the language of the document itself. The application of one or more polarity models in 712 may also relate to analysis of the document language, in which case step 714 is optionally not performed.

At 716, steps 712 and 714 are preferably repeated for each document in the ingested corpus. At 718, optionally the overall polarity and/or bias scores are determined for the entire corpus and hence for the brand itself. At 720, optionally changes to the overall polarity and/or bias scores over time are determined for the brand. Such changes may then be compared to the changes determined for one or more other brands, for example.

Optionally the polarity and/or bias scores, and/or changes thereto over time, are determined separately for content controlled by brand, such as advertisements and/or social media mentions controlled by the brand for example, and content that is not controlled by the brand, such as social media mentions by participants other than those controlled by the brand.

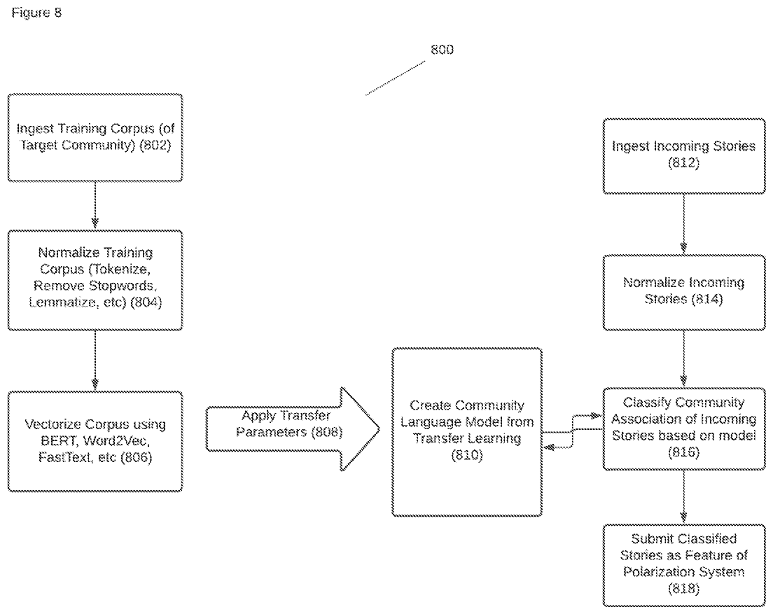

FIG. 8 shows a method for applying transfer learning to create a community based language classifier to detect polarity based upon community membership. As shown in a method 800, a training corpus is ingested at 802, which comprises a plurality of documents (and hence data) from the target community. The target community in this case represents a group with unique language usage (slang, specific use of words or phrases, etc). It can range from a radicalized community at one end of the religious or political spectrum, to a specific activist group that is interested in a particular cause. The documents are preferably selected to comprise a balanced representation of the types of documents, and of the types of language, in relation to the target community.

At 804, the documents in the training corpus are normalized. Normalization may comprise one or more of tokenization, removing stopwords, and removing non-useful words or characters, including but not limited to removing URLs, the beginning letters “RT” (which means the title is a retweet document, ex: RT @somebody), and so forth. The normalized title may then be split into bigrams (example: [[word0 word1],[word1 word2],[word2 word3], . . .]). Lemmatization may also be performed.

Various methods are known in the art for tokenization. For example and without limitation, a method for tokenization is described in Laboreiro, G. et al (2010, Tokenizing micro-blogging messages using a text classification approach, in ‘Proceedings of the fourth workshop on Analytics for noisy unstructured text data’, ACM, pp. 81-88).

Once the document has been broken down into tokens, optionally less relevant or noisy data is removed, for example to remove punctuation and stop words. A non-limiting method to remove such noise from tokenized text data is described in Heidarian (2011, Multi-clustering users in twitter dataset, in ‘International Conference on Software Technology and Engineering, 3rd (ICSTE 2011)’, ASME Press). Stemming may also be applied to the tokenized material, to further reduce the dimensionality of the document, as described for example in Porter (1980, ‘An algorithm for suffix stripping’, Program: electronic library and information systems 14(3), 130 137).

The tokens may then be fed to an algorithm for natural language processing (NLP) as described herein. The tokens may be analyzed for parts of speech and/or for other features which can assist in analysis and interpretation of the meaning of the tokens, as is known in the art.

At 806, the tokens are then converted to vectors. One method for assembling such vectors is through the Vector Space Model (VSM). Various vector libraries may be used to support various types of vector assembly methods, for example according to OpenGL. The VSM method results in a set of vectors on which addition and scalar multiplication can be applied, as described by Salton & Buckley (1988, ‘Term-weighting approaches in automatic text retrieval’, Information processing & management 24(5), 513-523).

To overcome a bias that may occur with longer documents, in which terms may appear with greater frequency due to length of the document rather than due to relevance, optionally the vectors are adjusted according to document length. Various non-limiting methods for adjusting the vectors may be applied, such as various types of normalizations, including but not limited to Euclidean normalization (Das et al., 2009, ‘Anonymizing edge-weighted social network graphs’, Computer Science, UC Santa Barbara, Tech. Rep. CS-2009-03); or the TF-IDF Ranking algorithm (Wu et al, 2010, Automatic generation of personalized annotation tags for twitter users, in ‘Human Language Technologies: The 2010 Annual Conference of the North American Chapter of the Association for Computational Linguistics’, Association for Computational Linguistics, pp. 689-692).

One non-limiting example of a suitable vectorization algorithm is word2vec, which produces vectors of words from text, known as word embeddings. Other non-limiting examples include BERT and FastText.

At 808, one or more transfer parameters are applied to the vectors. Such transfer parameters preferably comprise the final layers learned from the addition of the labeled training data, specific to the community model Upon application of these parameters, the model moves beyond pure embedding/transformation to classification. In this case, the label is “of this community” or “not of this community”. The final phase of transfer learning produces a model that acts as a classifier for these labels. This layer represents the “transfer parameters”. The application of such parameters is preferably determined according to the vectorization algorithm that was previously applied.

A community language model is then created from the application of the transfer parameters to the vectors at 810. This language model is adapted to the particular community of interest, and hence is able to analyze the language of documents from that community with greater accuracy than a general language model.

At 812, stories to be analyzed according to the community language model are ingested, and then at 814, these stories are normalized, as previously described. At 816, the normalized stories are analyzed with the community language model, to determine whether they are associated with that particular community. Such an analysis determines whether the language used is associated with that community, and hence whether the story itself is associated with that community. At 818, stories that have been classified as being associated with that community are input to the polarization system as a feature, including the community association.

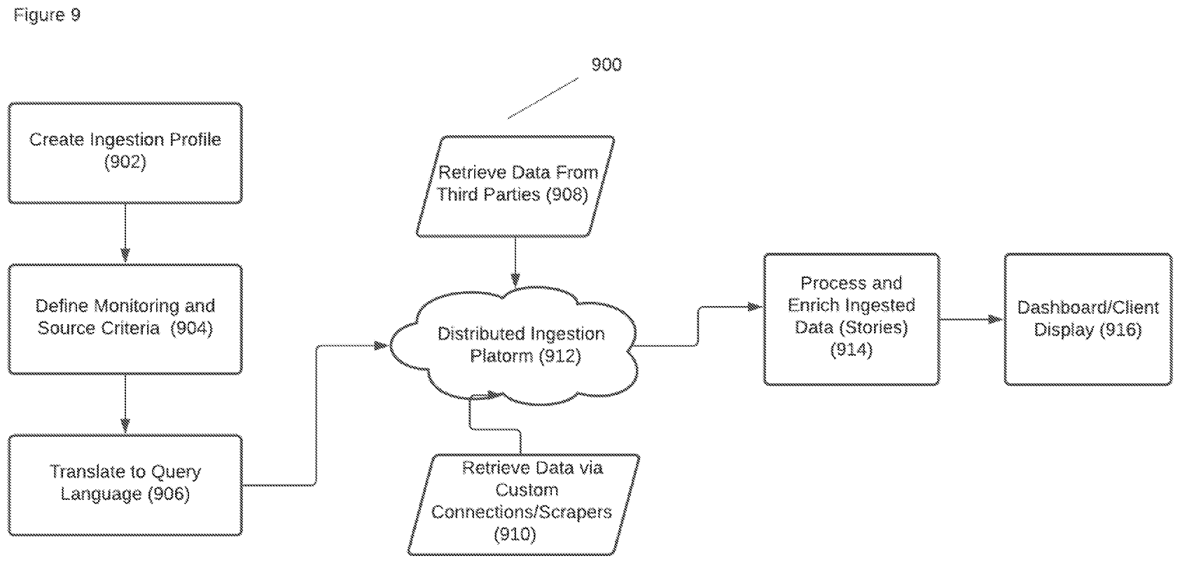

FIG. 9 shows an exemplary method for data ingestion. As shown in a method 900, the method begins with creating an ingestion profile at 902. as previously described. At 904, monitoring and source criteria are defined, to determine which document source(s) are to be associated with that ingestion profile, and also the frequency of ingestion. At 906, these criteria are translated to a query language. The query language may for example be SQL-based and is preferably customized beyond the initial base. It allows a standardized interface to the different data sources that are ingested and their own custom query languages. The application of the query language to the criteria enables the relevant documents to be ingested.

At 908, data is (documents are) retrieved from a third party or parties, according to the query language, by an ingestion platform 912. The ingestion platform may for example use custom connections and/or web scrapers at 910. A non-limiting example of a custom connection is a connection to a social media API, such as for example and without limitation, the API of Facebook, Twitter, Instagram and the like.

The ingested documents (data), preferably comprising one or more stories, are then processed and enriched at 914, as previously described. At 916, the processed data may then be displayed at a client dashboard, for example.

The present disclosure is described above with reference to block diagrams and flowchart illustrations of method and system embodying the present disclosure. It will be understood that various blocks of the block diagram and flowchart illustrations, and combinations of blocks in the block diagrams and flowchart illustrations, respectively, may be implemented by a set of computer program instructions. These set of instructions may be loaded onto a general purpose computer, special purpose computer, or other programmable data processing apparatus to cause a device, such that the set of instructions when executed on the computer or other programmable data processing apparatus create a means for implementing the functions specified in the flowchart block or blocks. Although other means for implementing the functions including various combinations of hardware, firmware and software as described herein may also be employed.

Various embodiments described above may be implemented in software, hardware, application logic or a combination of software, hardware and application logic. The software, application logic and/or hardware may reside on at least one memory, at least one processor, an apparatus or, a non-transitory computer program product. In an example embodiment, the application logic, software or an instruction set is maintained on any one of various conventional computer-readable media. In the context of this document, a “computer-readable medium” may be any non-transitory media or means that can contain, store, communicate, propagate or transport the instructions for use by or in connection with an instruction execution system, apparatus, or device, such as a computer, as shown herein. A computer-readable medium may comprise a computer-readable storage medium that may be any media or means that can contain or store the instructions for use by or in connection with an instruction execution system, apparatus, or device, such as a computer.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application/or implementation without departing from the spirit or scope of the disclosure.

What is claimed is:

1. A system for determining polarization in a plurality of documents obtained from one or more information sources, comprising a polarization model source and a server, said server comprising a processor for executing a plurality of instructions and a memory for storing said instructions, said instructions comprising instructions for receiving said plurality of documents and for applying a polarization model from said polarization model source to determine polarization of said plurality of documents, wherein said applying said polarization model comprises one or more of analyzing each document itself and/or said publication source of the document.

2. The system of claim 1, wherein said instructions in said memory of said server further comprise instructions for receiving a topic model and for applying said topic model for tagging one or more such documents.

3. The system of claim 2, wherein said one or more information sources comprise one or more of a social media platform, online newspaper, online magazine, blog, newsletter, podcast, television show, website, brand announcement or brand sponsored content.

4. The system of claim 1, further comprising a client computational device comprising a display, a processor and a memory, wherein said memory stores a plurality of instructions for receiving polarization information from said server and for displaying said polarization information in a dashboard displayed on said display.

5. The system of claim 1, wherein said instructions in said memory of said server further comprise instructions for determining a bias score for said plurality of documents.

6. The system of claim 1, wherein said server receives said plurality of documents from said one or more information sources according to a time window for ingestion.

7. The system of claim 1, wherein said instructions stored in said memory of said server further comprise instructions for receiving a community language model associated with a community, and for analyzing said one or more information sources to determine whether each of said one or more information sources is associated with said community.

8. The system of claim 1, wherein said instructions stored in said memory further comprise instructions for applying a polarization measure to a plurality of documents to label said documents for training said polarization model.

9. The system of claim 8, wherein said polarization measure is determined according to a publication source.

10. The system of claim 8, wherein said polarization measure is determined according to a previously determined polarization analysis.

11. The system of claim 8, wherein said polarization measure is determined according to a plurality of keywords.

12. The system of claim 1, wherein said instructions stored in said memory further comprise instructions for applying a Polarization Index to a plurality of documents to label said documents for training said polarization model, wherein said Polarization Index is determined according to a plurality of standardized polarization measures.

13. The system of claim 1, wherein said instructions stored in said memory further comprise instructions for applying a media category model to a plurality of documents to label said documents for training said polarization model.

14. The system of claim 13, wherein said instructions stored in said memory further comprise instructions for applying a topic model after applying said media category model.

15. The system of claim 13, wherein said instructions stored in said memory further comprise instructions for applying a topic model before applying said media category model.

16. The system of claim 1, wherein said instructions stored in said memory further comprise instructions for applying a media category model to a plurality of documents before applying said polarization measure.

17. The system of claim 16, wherein said instructions stored in said memory further comprise instructions for applying a topic model before applying said media category model.

18. The system of claim 16, wherein said instructions stored in said memory further comprise instructions for applying a topic model after applying said media category model.

19. A system for determining polarization in a plurality of documents obtained from one or more information sources, comprising a polarization measure source and a server, said server comprising a processor for executing a plurality of instructions and a memory for storing said instructions, said instructions comprising instructions for receiving said plurality of documents and for applying a polarization measure from said polarization measure source to determine polarization of said plurality of documents, wherein said applying said polarization measure comprises one or more of analyzing each document itself and/or said publication source of the document.

20. The system of claim 19, wherein said polarization measure is determined according to a publication source.

21. The system of claim 19, wherein said polarization measure is determined according to a previously determined polarization analysis.

22. The system of claim 19, wherein said polarization measure is determined according to a plurality of keywords.

23. The system of claim 19, wherein said instructions stored in said memory further comprise instructions for applying a Polarization Index to a plurality of documents to as said polarization measure, wherein said Polarization Index is determined according to a plurality of standardized polarization measures.

24. The system of claim 19, wherein said instructions in said memory of said server further comprise instructions for receiving a topic model and for applying said topic model for tagging one or more such documents.

25. The system of claim 19, wherein said one or more information sources comprise one or more of a social media platform, online newspaper, online magazine, blog, newsletter, podcast, television show, website, brand announcement or brand sponsored content.

26. The system of claim 19, further comprising a client computational device comprising a display, a processor and a memory, wherein said memory stores a plurality of instructions for receiving polarization information from said server and for displaying said polarization information in a dashboard displayed on said display.
